(19) United States
(12) Patent Application Publication
(10) Pub. No.: US 2003/0187599 A1
(43) Pub. Date: Oct. 2, 2003

(54) Circuit for measuring rising or falling time of high-speed data and method thereof

(76) Inventors: Du-sik Yoo, Anyang-city (KR); Young-boo Kim, Yongin-city (KR); Jin-mo Jang, Bucheon-city (KR)

Correspondence Address: HARNESS, DICKEY & PIERCE, P.L.C., P.O. BOX 8910, RESTON, VA, 20195, US

(21) Appl. No.: 10/315,024

(22) Filed: Dec. 10, 2002

(30) Foreign Application Priority Data
Apr. 2, 2002 (KR) 2002-18054

(51) Int. Cl. G06F 19/00

(52) U.S. Cl. 702/79

(57) ABSTRACT

A circuit and a method for measuring rising or falling time of high-speed data are disclosed. The circuit includes a comparator and a storage circuit. The comparator receives the high-speed data via a first port and a reference signal via a second port, compares a level of the high-speed data with a level of the reference signal in response to an enable signal, and outputs the compared result as a signal. A reference signal generator generates the reference signal. An enable signal generator generates the enable signal. The storage circuit receives and stores the signal and measures the rising or falling time of the high-speed data.

This U.S. non-provisional patent application claims priority under 35 U.S.C. § 119 to Korean Patent Application No. 2002-18054 filed on Apr. 2, 2002, the contents of which are hereby incorporated by reference.

### BACKGROUND OF THE INVENTION

1. Field of the Invention

The present invention generally relates to a test circuit, and more particularly, to a circuit for measuring a rising or falling time of high-speed data and method thereof.

2. Description of the Related Art

With the advance of techniques for high-speed data, test circuits for measuring rising or falling times of high-speed data have been developed and are currently under development.

Currently, developed test circuits for testing rising or falling times of high-speed data have difficulty measuring the rising or falling times (about 200 ps, about 5 Ghz) of high-speed data being about 2.0 Gbps or more. The particular difficulty stems from the fact that the rising or falling times of high-speed data are too short.

Test circuits capable of measuring a bandwidth wider than a bandwidth of high-speed data are required to measure rising or failing times of high-speed data. However, it is impossible to develop test circuits capable of measuring a bandwidth wider than the bandwidth of high-speed data, due to current bandwidth limits of test circuit buses. Therefore, current test circuits use external measuring instruments to measure rising or falling times of high-speed data.

FIG. 1 illustrates a conventional test circuit and external measuring instrument for measuring rising or falling times of high-speed data. Referring to FIG. 1, a test circuit for measuring rising or falling times of high-speed data includes a device under test (DUT) 110, an automatic test equipment (ATE) 140, and a time measuring instrument 130 that is an external measuring instrument.

The DUT 100 includes a high-speed data generator 120 for generating high-speed data TXP, TXN. The high-speed data generator 120 receives high-speed parallel data and outputs the data as high-speed series data. In FIG. 1, the high-speed data generator 120 is embodied as a serializer deserializer (SERDES). However, the high-speed data generator 120 is not necessarily limited to the SERDES. That is, other high-speed data generators having similar operational characteristics may also be used. The SERDES 120 outputs high-speed series data TXP, TXN, and the outputted high-speed data TXP and TXN have a complementary phase relationship.

The ATE 140 is test equipment which inputs a reference clock signal REFCLK and 10 bit parallel data TX to the SERDES 120. The reference clock signal REFCLK has a frequency of 106.25 MHz. The time measuring instrument 130 is installed outside the test equipment and measures velocities of high-speed data TXP, TXN output from the SERDES 120 to output them to the ATE 140. The time measuring instrument 130 may be an oscilloscope. The ATE 140 receives the output of the time measuring instrument 130 via a bus BL and deciphers it.

FIG. 2 illustrates waveforms of high-speed data that is output from a DUT, illustrated in FIG. 1. As illustrated in FIG. 2, the high-speed data TXP, TXN have half period of 2.125 Gbps, respectively. Rising time TR and falling time TF of the high-speed data TXP, TXN represent that the time required for 20-80% of high level of a rising edge or falling edge of the high-speed data TXP, TXN.

The test system 100 shown in FIG. 1 uses the external time measuring instrument 130 in addition to the ATE 140. Moreover, the test system 100 uses one time measuring instrument per each DUT. The use of the foregoing results in the increase of the overall cost of the time measuring instrument 130.

Also, if a test duration increases for transmitting and receiving information relating to a measured time between the time measuring instrument 130 and the ATE 140, or if a calibration problem of the time measuring instrument 130 occurs, the quality of manufactured products may be deteriorated.

### SUMMARY OF THE INVENTION

An exemplary embodiment of the present invention provides a circuit and a system capable of measuring rising and falling times of high-speed data without using an external measuring instrument.

An additional exemplary embodiment of the present invention to provides a method of measuring rising and falling times of high-speed data without using an external measuring instrument.

Accordingly in one or more exemplary embodiments of the present invention, there is provided a circuit for measuring rising or falling time of high-speed data. The circuit includes a comparator and a storage circuit. The comparator receives the high-speed data via a first port and a reference signal via a second port, compares a level of the high-speed data with a level of the reference signal in response to an enable signal, and outputs the compared result as a signal. The storage circuit receives and stores the signal and measures the rising or falling time of the high-speed data.

The reference signal has a stepped waveform and a period of one step is T, and high level and low level thereof may be distinguished by N step(s). The period T may be longer than an M bit time of the high-speed data, by a time T1. The time T1 may be variable.

The comparator compares the level of the high-speed data with the level of the reference signal for an upper M/2 bit time of the high-speed data in response to the enable signal, and the storage circuit stores the signal for a lower M/2 bit time of the high-speed data. A high level of the reference signal is higher than a high level of the high-speed data, and a low level of the reference signal is lower than a low level of the high-speed data.

The enable signal has substantially the same period as the period T of one step of the reference signal, and the level of the high-speed data is compared with the level of the reference signal in response to a first edge of the enable signal.

According to an exemplary embodiment of the present invention, there is provided a system for measuring rising or falling time of high-speed data. The system includes a device under test board and automatic equipment. The device under test board receives the high-speed data and a reference signal, compares a level of the high-speed data with a level of the reference signal in response to an enable signal, and outputs the compared result as a signal.

The automatic test equipment generates the reference signal and the enable signal, receives the signal, and measures the rising or falling time of the high-speed data.

The device under test board includes a data generator and a comparator. The data generator generates the high-speed data. The comparator receives the high-speed data via a first port and the reference signal via a second port and outputs the signal in response to the enable signal.

The automatic test equipment includes a reference signal generator, an enable signal generator, and a storage circuit. The reference signal generator generates the reference signal. The enable signal generator generates the enable signal. The storage circuit receives and stores the signal and measures the rising or falling time of the high-speed data.

Furthermore, according to another exemplary embodiment of the present invention, there is provided a method of measuring rising or falling time of high-speed data. The high-speed data and a reference signal are received. A level of the high-speed data is compared with a level of the reference signal in response to an enable signal and the compared result is output as a signal. The signal is stored in a memory array and the rising or falling time of the high-speed data is measured from the stored signal.

The reference signal has a stepped waveform and a period of one step is T, and high level and low level thereof are distinguished by N step(s). The period T may be longer than an M bit time of the high-speed data, by a time T1. The time T1 may be variable.

The level of the high-speed data is compared with the level of the reference signal for an upper M/2 bit time of the high-speed data in response to the enable signal, and the signal is stored in the memory array for a lower M/2 bit time of the high-speed data. A high level of the reference signal is higher than a high level of the high-speed data, and a low level of the reference signal is lower than a low level of the high-speed data. The enable signal has substantially the same period as the period T of one step of the reference signal, and the level of the high-speed data is compared with the level of the reference signal in response to a first edge of the enable signal.

As described above, the circuit and method according to exemplary embodiments of the present invention may measure rising or falling time of high-speed data without using an external measuring instrument.

Further scope of applicability of the present invention will become apparent from the detailed description given hereinafter. However, it should be understood that the detailed description and specific examples, while indicating exemplary embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 illustrates a test circuit and external measuring instrument for measuring rising or falling time of high-speed data;

FIG. 2 illustrates waveforms of high-speed data output from a DUT shown in FIG. 1;

FIG. 3 illustrates a block diagram of a circuit for measuring rising or falling time of high-speed data according to an exemplary embodiment of the present invention;

FIG. 4 illustrates an exemplary waveform of high-speed data in FIG. 3;

FIG. 5 illustrates an exemplary waveform of a reference signal of FIG. 3;

FIG. 6 illustrates an exemplary waveform of an enable signal of FIG. 3;

FIG. 7 illustrates an exemplary waveform showing the relationship between high-speed data and the exemplary enable signal of FIG. 3;

FIG. 8 illustrates a method of measuring high-speed data of FIG. 3 by an under-sampling method, analyzing an output signal, and determining rising or falling time of the high-speed data an exemplary embodiment of the present invention;

FIG. 9 illustrates a block diagram of a system for measuring rising or falling time of high-speed data according to another exemplary embodiment of the present invention; and

FIG. 10 illustrates a flowchart of a method of measuring rising or falling time of high-speed data according to an exemplary embodiment of the present invention.

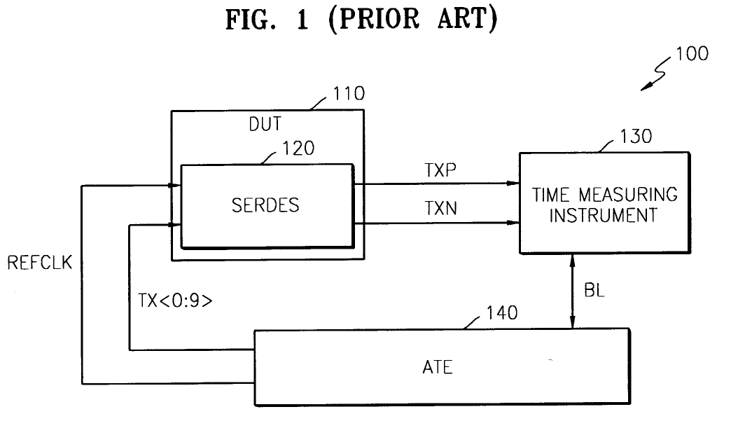

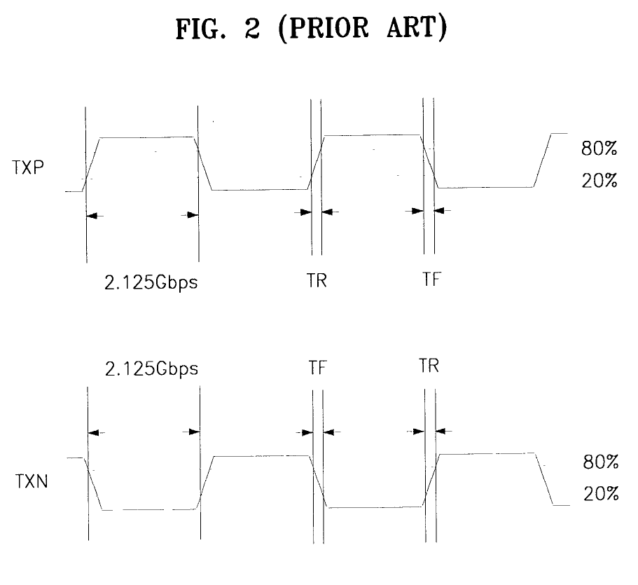

### DETAILED DESCRIPTION OF EXEMPLARY EMBODIMENTS

Attached are drawings for illustrating exemplary embodiments of the present invention. The contents written on the attached drawings may be referred to in order to gain an understanding of the merits of the exemplary embodiments of the present invention and the operation thereof.

Hereinafter, the exemplary embodiments of the present invention will be described in detail with reference to the attached drawings. Like reference numerals in the drawings denote the same members.

Although the exemplary embodiments of the present invention are described herein with reference to high-speed data, the present invention may operate on data of varying speed levels. For example, the exemplary embodiments of the present invention are functional with data having both low and medium speed levels.

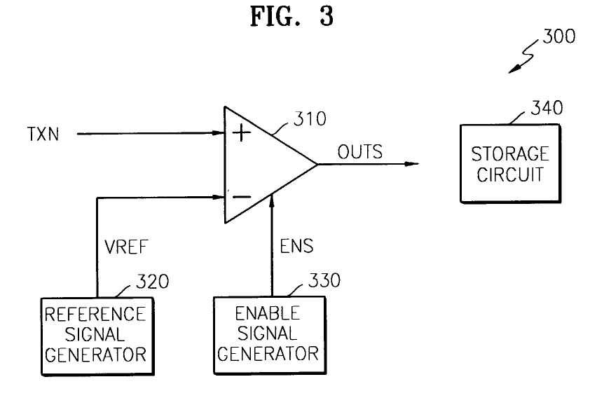

Referring to FIGS. 3 through 8, a circuit 300 for measuring rising or falling time of high-speed data according to an exemplary embodiment of the present invention includes a comparator 310 and a storage circuit 340. The circuit 300 may further include a reference signal generator 320 and an enable signal generator 330.

The comparator 310 receives high-speed data TXN via a first port and a reference signal VREF via a second port, compares a level of the high-speed data TXN with a level of the reference signal VREF, and output the compared result as a signal OUTS in response to an enable signal ENS.

The reference signal generator 320 generates the reference signal VREF. The reference signal VREF has a stepped waveform signal, where one step has a period T and a high level and a low level thereof are distinguished by N step(s). The period T may be longer than an M bit time of the high-speed data, by a time T1. The time T1 may be variable.

In response to the enable signal ENS, the level of the high-speed data TXN is compared with the level of the reference signal VREG for an upper M/2 bit time of the high-speed data TXN. The storage circuit 340 stores the signal OUTS for a lower M/2 bit time of the high-speed data TXN. A high level HIGH2 of the reference signal VREF is higher than high level HIGH1 of the high-speed data TXN, and low level LOW2 of the reference signal VREF is lower than low level LOW 1 of the high-speed data TXN.

The enable signal generator 330 generates the enable signal ENS, which has the same period as the period T of one step of the reference signal VREF. The level of the high-speed data TXN is compared with the level of the reference signal VREF in response to a first edge of the enable signal ENS.

The storage circuit 340 receives and stores the signal OUTS and measures the rising or falling time of the high-speed data TXN.

Hereinafter, the operation of a circuit for measuring rising or falling time of high-speed data according to an exemplary embodiment of the present invention will be described in detail with reference to FIGS. 3 through 8.

The comparator 310 receives the high-speed data TXN via the first port and the reference signal VREF via the second port, compares the level of high-speed data TXN with the level of the reference signal VREF, and outputs the compared result as the signal OUTS in response to the enable signal ENS.

The high-speed data TXN has a rate of 2.0 Gbps or more. In an exemplary embodiment of the present invention, the high-speed data TXN is a signal output from a SERDES.

The comparator 310 may be a general high-speed comparator, which can be understood by one of ordinary skill in the art of the present invention. Therefore, a detailed discussion of its configuration and operation is omitted.

The comparator 310 receives the high-speed data TXN via the first port and the reference signal VREF via the second port. The first port may be a positive port of the comparator 310 and the second port may be a negative port of the comparator 310. However, the comparator 310 may be configured so that the first port is negative and the second port is positive.

The comparator 310 compares the level of the high-speed data TXN with the level of the reference signal VREF in response to the enable signal ENS and outputs the compared result as the signal OUTS. The high-speed data TXN is input to the positive port of the comparator 310 and the reference signal VREF is input to the negative port of the comparator 310. Thus, the signal OUTS is high if the level of the high-speed data TXN is higher than the level of the reference signal VREF, while the signal OUTS is low if the level of the high-speed data TXN is lower than the level of the reference signal VREF.

The storage circuit 340 stores the signal OUTS. The logic level of the signal OUTS may be used to determine rising and falling times of the high-speed data TXN. The storage circuit 340 may be a memory array.

The reference signal generator 320 may be a very high frequency arbitrary wave generator (VHFAWG), which can generate high frequency signals having varying cycles. The reference signal VREF has a stepped waveform.

The enable signal generator 330 is a VHFAWG which can generate high frequency signals having variying cycles. The enable signal ENS has a pulse waveform.

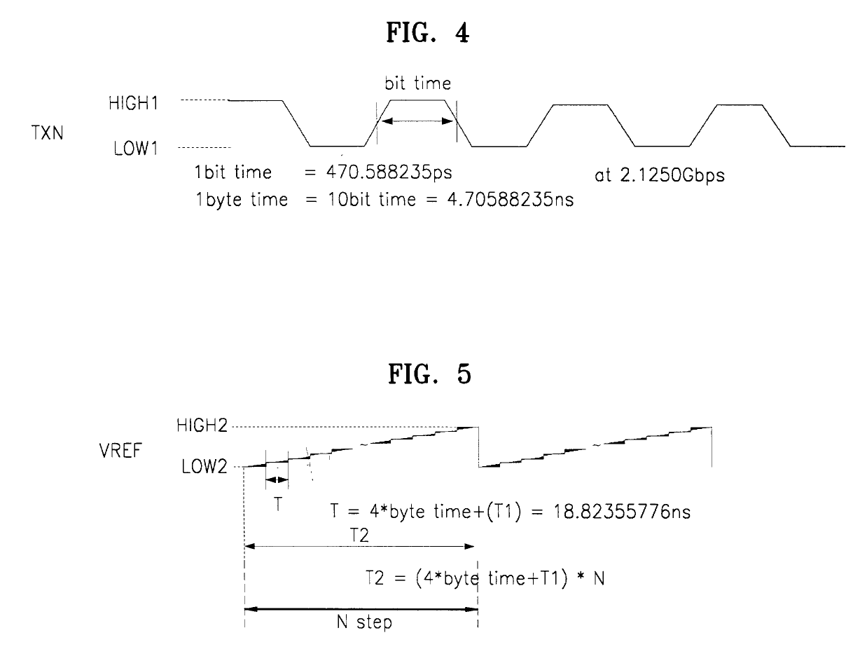

Referring to FIG. 4, in an exemplary embodiment of the present invention, 1 bit time of the high-speed data TXN of 2.125 Gbps is 470.588235 ps. Moreover, 1 byte time of the high-speed data TXN is equal to 10 bit time which is 4.70588235 ns.

FIG. 5 illustrates the reference signal VREF generated by the reference signal generator 320 of an exemplary embodiment of the present invention. The reference signal VREF has a stepped waveform signal, where one step thereof has a period T. The period T may be longer than an M bit time of the high-speed data, by a time T1. The time T1 may be variable. In one embodiment of the present invention the M is 40. In other words, the period T equals 40 bit time (4 bytes) of the high-speed data TNS plus a time T1. The period T is calculated to be 18.82355776 ns. Here, the time T1 is 1/80 Hz.

The time T1 is constant time for the use in conjunction with an under sampling method. Because the rate of the high-speed data TXN is fast, it is difficult to measure a rising or falling time of the high-speed data TXN by performing one time sampling of each bit of the high-speed data TXN. In particular, one time sampling is performed every 40 bits of the high-speed data TXN. The sampling is then performed hundreds of thousands of times or more. The sampled results are analyzed to measure the rising or falling time of the high-speed data TXN.

According to an exemplary embodiment of the present invention, the sampling period is a time T1 longer than 40 bit time. Therefore, the sampling is performed in a position which is moved by the time T1 compared to the previous 40 bit sampling position. The sampling is repeated hundreds of thousands of times and sampled results are summed up, which are equal to sampling results of each bit of the high-speed data. The time T1 is variable, and thus, more precise sampling is possible if the time T1 becomes smaller.

The N step(s) distinguishes between the high level and low level of the reference signal VREF. According to an exemplary embodiment of the present invention, N is 20. In other words, the reference signal VREF is a stepped waveform signal having one step with the period T. Moreover, the high level and low level of the reference signal VREF are distinguished by 20 steps. Thus, the period T of one step multiplied by N is a period T2 of the reference signal VREF. In one example, N is variable. More precise sampling is possible if N becomes greater.

The high level of the reference signal VREF is higher than the high level of the high-speed data TXN and the low level of the reference signal VREF is lower than the low level of the high-speed data TXN. Thus, more accurate results can be obtained from the comparison of the level of the reference signal VREF and the level of the high-speed data TXN.

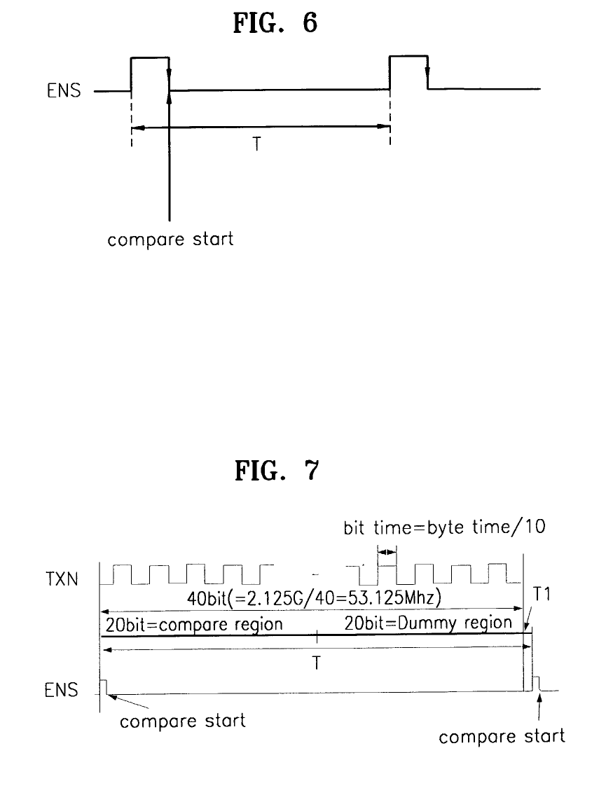

Referring to FIG. 6, according to an exemplary embodiment of the present invention, the enable signal generator 330 generates the enable signal ENS, which has a pulse waveform having substantially the same period as the period T of one step of the reference signal VREF. The level of the high-speed data TXN is compared with the level of the reference signal VREF in response to a first edge of the enable signal ENS. In an embodiment of the present invention, the first edge represents a falling edge. However, the first edge may be a rising edge if the configuration of the enable signal generator 330 varies.

The enable signal ENS becomes high the moment the period T of one step of the reference signal VREF starts. The level of the high-speed data TXN is compared with the level of the reference signal VREF the moment the enable signal ENS becomes a first level, i.e., a low level.

A total of 40 bits of the high-speed data is illustrated in FIG. 7 in an exemplary embodiment of the present invention. The level of the high-speed data TXN is compared with the level of the reference signal VREF, every 40 bits of the high-speed data TXN in response to a falling edge of the enable signal ENS. Therefore, in response to the enable signal ENS, a one time under sampling is performed every 40 bits of the high-speed data TXN.

The level of the high-speed data TXN is compared with the level of the reference signal VREF for a high M/2 bit time of the high-speed data TXN, and the signal OUTS is stored in the storage circuit 340 for a low M/2 bit time. In particular, since M is 40, the level of the high-speed data TXN is compared with the level of the reference signal VREF for a high 20 bit time of the high-speed data TXN, and the signal OUTS is stored in the storage circuit 20 for a low 20 bit time of the high-speed data TXN.

The period of 40 bits of the high-speed data TXN is 53.125 Mhz. Thus, the period T of one step of the reference signal VREF is 53.124920 Mhz, which is reduced by 80 hz compared to 53.125 Mhz. The 80 hz is a variable value T1, and the period T of one step of the reference signal VREF is 18.82355776 ns since time increases with a reduction in a frequency. The variable value T1 is used to control sampling resolution.

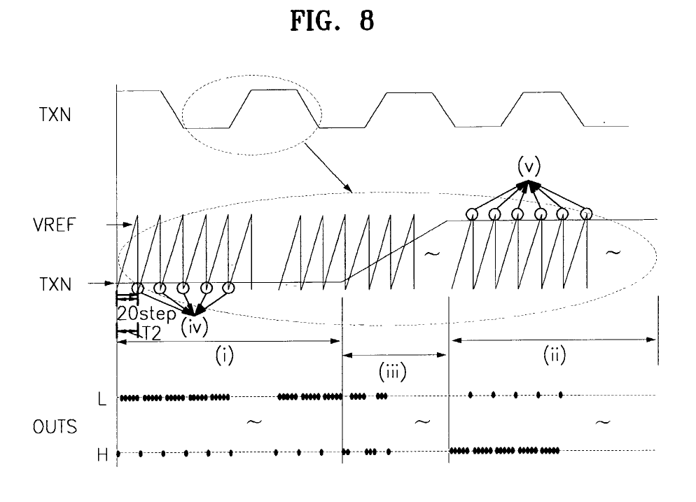

FIG. 8 illustrates the high-speed data TXN, the reference signal VREF, and the signal OUTS in an exemplary embodiment of the present invention. The reference signal VREF is shown having triangular waves, each of which is composed of 20 steps. Thus, a period of each triangular wave is equal to T2 shown in FIG. 5. One enlarged rising edge of the high-speed data TXN is shown.

One step of one triangular wave corresponds to 40 bits of the high-speed data TXN. Therefore, one triangular wave corresponds to 800 bits of the high-speed data TXN. Since one time under sampling is performed each one step of the reference signal VREF, in response to a falling edge of the enable signal ENS, twenty-time under sampling is performed each one triangular wave. In the under sampling method according to an exemplary embodiment of the present invention, the size of T1 determines sampling resolution.

One bit time of the high-speed data TXN is 470 ps. Thus, the number of samples within 1 bit of the high-speed data TXN can be calculated by dividing 1 bit time of the high-speed data TXN by T1. Therefore, the number of samples is 15800 times. If the rising or falling time is 110 ps, the number of samples within a rising or falling time can be calculated by dividing 110 ps by T1. Accordingly, the number of samples is 3880 times. Therefore, since sampling is performed twenty times when a triangular wave of the reference signal VREF is generated within a period T2 composed of 20 steps, a triangular wave of the reference signal VREF, which is composed of 20 steps, is generated 194 times for the rising or falling time of 110 ps. This means that 194 triangular waves of the reference signal VREF illustrated in FIG. 8 are generated for one rising or falling time of the high-speed data TXN.

If the high-speed data TXN is low, the levels of the reference signal VREF are higher than the levels of the high-speed data TXN in the other sections, except for a section iv (specific sections are illustrated in FIG. 8) where the level of the reference signal VREF is lower than the level of the high-speed data TXN. Thus, low level signals OUTS are output. Therefore, many low level signals OUTS are output in a section i where the high-speed data TXN is low. In FIG. 8, black dots represent the signal OUTS and it can be seen that there are many black dots in the section i where the high-speed data TXN is low.

If the high-speed data TXN is high, the level of the reference signal VREF is lower than the level of the high-speed data TXN, except for in section v where the level of the reference signal VREF is higher than the level of the high-speed data TXN. Thus, the signal OUTS becomes high. In other words, many periods of the signal OUTS become high in a section ii where the high-speed data TXN is high. In FIG. 8, black dots represent the signal OUTS and it can be seen that there are many black dots in the section ii where the high-speed data TXN is high.

A rising or falling time section iii of the high-speed data TXN, as illustrated in FIG. 8, will now be described. If rising sections increase, where the levels of the high-speed data TXN are higher than the levels of the reference signal VREF, the number of output high level signals OUTS increases. In contrast, if falling sections increase, where the levels of the high-speed data TXN are lower than the levels of the reference signal VREF increase, the number of output low level signals OUTS increases.

In other words, in the low level sections of the high-speed data TXN, a number of signals OUTS are output as low levels, and a ratio of the low levels to the high levels is regular. However, the number of signals OUTS output as high levels increases in the rising sections of the high-speed data TXN, and the number of signals OUTS output as low levels increases in the falling sections of the high-speed data TXN.

Accordingly, the storage circuit 340 stores signals OUTS output from sections, where the number of low or high levels of the signals OUTS gradually increases or decreases. Also, the number of samplings is obtained in the indicated sections to obtain times of the rising or falling sections of the high-speed data TXN. Since the number of the output signals OUTS is equal to the number of samplings, the times of rising or falling sections of the high-speed data TXN can be obtained using the number of the output signals OUTS. Sections within a range of 20-80% are detected from the obtained times and rising or falling times of the high-speed data TXN are measured from the number of samplings.

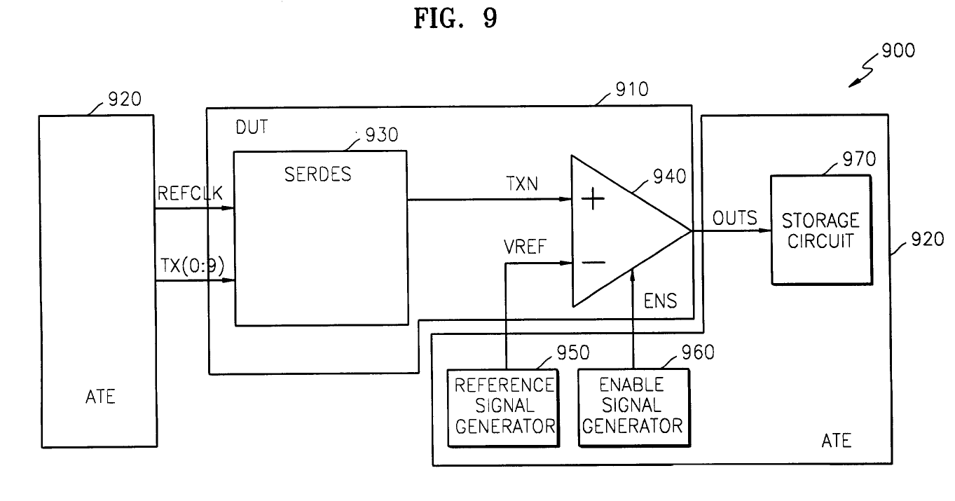

FIG. 9 illustrates a block diagram of a system for measuring rising or falling time of high-speed data according to an exemplary embodiment of the present invention. Referring to FIG. 9, a system 900 for measuring rising or falling time of high-speed data according to an exemplary embodiment of the present invention includes a DUT board 910 and an ATE.

The DUT board 910 receives high-speed data TXN and a reference signal VREF, compares a level of the high-speed data TXN with a level of the reference signal VREF in response to an enable signal ENS, and outputs the compared result as a signal OUTS.

In more detail, the DUT board 910 includes a data generator 930 and a comparator 940. The data generator 930 generates the high-speed data TXN. The comparator 940 receives the high-speed data TXN via a first port and the reference signal VREF via a second port and outputs the signal OUTS in response to the enable signal ENS.

The ATE 920 generates the reference signal VREF and the enable signal ENS and receives the signal OUTS to measure rising or falling time of the high-speed data TXN.

The ATE 920 includes a reference signal generator 950, an enable signal generator 960, and a storage circuit 970. The reference signal generator 950 generates the reference signal VREF. The enable signal generator 960 generates the enable signal ENS. The storage circuit 970 receives and stores the signal OUTS and measures the rising or falling time of the high-speed data TXN.

The operation of the system for measuring the rising or falling time of the high-speed data will now be described with reference to FIG. 9.

The data generator 930 in the DUT board 910 generates the high-speed data TXN. The high-speed data TXN has a rate of 2.0 Gbps. The data generator 930 is a SERDES which receives parallel data and outputs the data as high-speed series data. The SERDES 930 receives a reference clock signal REFCLK and 10-bit parallel data TX from the ATE 920 and outputs high-speed series data TXN. The data generator 930 is indicated as a SERDES by way of example only. In particular, other data generators may also be used with the exemplary embodiments of the present invention as needed and as on-hand supply require.

The comparator 940 receives the high-speed data via the first port and the reference signal VREF via the second port. The first port is positive and the second port is negative. However, the opposite is also possible. The reference signal generator 950 in the ATE 920 generates the reference signal VREF. The comparator 940 is a high-speed comparator. The comparator 940 compares the level of the high-speed data TXN with the level of the reference signal VREF and outputs the compared result as the signal OUTS in response to the enable signal ENS.

The reference signal generator 950 in the ATE 920 generates the reference signal VREF. The reference signal generator 950 may be a Very High Frequency Arbitrary Wave Generator (VHFAWG), which can generate a signal having a high frequency with various waves. The reference signal VREF may have a stepped waveform.

The enable signal generator 960 in the ATE 920 may be a VHFAWG which can generate high frequency signals having varying cycles. The enable signal ENS may have a pulse waveform.

The storage circuit 970 in the ATE 920 receives and stores the signal OUTS and measures the rising or falling time of the high-speed data TXN.

On or more of the comparator 940, the reference signal generator 950, the enable signal generator 960, and the storage circuit 920 included in the system 900 according to an embodiment of the present invention may be the same as the comparator 310, the reference signal generator 320, the enable signal generator 330, and the storage circuit 340 in another embodiment of the present invention. Also, the operation of each circuit in this exemplary embodiment may be the same as that in the prior discussed exemplary embodiment. Thus, detailed descriptions of the operation of the system 900 are omitted.

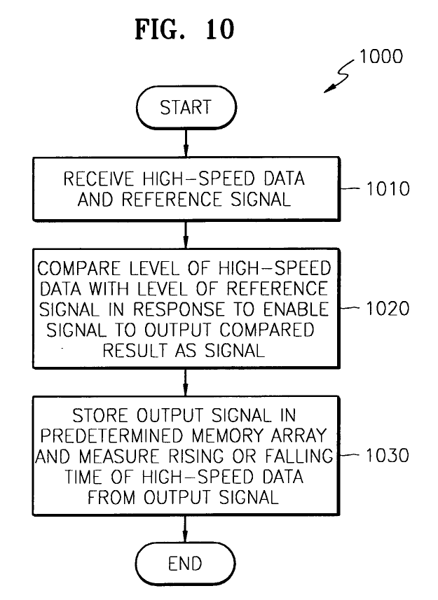

FIG. 10 is a flowchart of a method of measuring rising or falling time of high-speed data.

In a method 1000 of measuring rising or falling time of high-speed data, high-speed data and a reference signal are received in step 1010. In step 1020, a level of the high-speed data is compared with a level of the reference signal in response to an enable signal to thereby output a signal. In step 1030, the signal is stored in a memory array and the rising or falling time of the high-speed data is measured from the stored signal.

The method of measuring the rising or falling time of the high-speed data will be described in more detail with reference to FIG. 10.

The high-speed data having a rate of 2.0 Gbps is received in step 1010. Accordingly, the high-speed data is data output from a SERDES that receives parallel data and outputs it as high-speed series data.

The reference signal is received in step 1010. The reference signal has a stepped waveform and a period of one step is T and high level and low level thereof are distinguished by N step(s). The period T is a time T1 longer than an M bit time of the high-speed data where the time T1 is variable.

In step 1020, the level of the high-speed data is compared with the level of the reference signal in response to the enable signal to output a signal.

The reference signal is the same as the reference signal generated in the circuit 300, shown in FIG. 3, for measuring the rising or falling time of the high-speed data. The, a 40 bit time of the high-speed data plus the time T1 equals the period T, i.e., 18.82355776 ns. The time T1 is 1/80 Hz.

The time T1 is a constant time for the use of an under sampling method. Therefore, since the rate of the high-speed data TXN is fast, it is difficult to measure rising or falling time of the high-speed data TXN by performing one time sampling each bit of the high-speed data TXN. In other words, one time sampling is performed every 40 bits of the high-speed data TXN, and then such sampling is performed hundreds of thousands of times or more. The sampled results are analyzed to measure the rising or falling time of the high-speed data TXN.

In this case, the sampling period is a time T1 longer than 40 bit time. Accordingly, the sampling is performed in a position which is moved by the time T1 compared to the previous 40 bit sampling position. The sampling is repeated hundreds of thousands of times and the sampled results are summed up, which are equal to sampling results of each bit of the high-speed data. The time T1 is variable, and thus, more precise sampling is possible if the time T1 becomes smaller.

The high level of the reference signal VREF is higher than the high level of the high-speed data TXN and the low level of the reference signal VREF is lower than the low level of the high-speed data TXN. Thus, more accurate results can be obtained from the comparison of the level of the reference signal VREF and the level of the high-speed data TXN.

The enable signal ENS has a pulse waveform with the same period as the period T of one step of the reference signal VREF. The enable signal ENS becomes high the moment the period T of one step of the reference signal VREF starts. The level of the high-speed data TXN is compared with the level of the reference signal VREF the moment the enable signal ENS becomes a first level, i.e., a low level. However, the level of the high-speed data may be compared with the level of the reference signal when the enable signal is high, which is obvious to those skilled in the art of the present invention.

The level of the high-speed data TXN is compared with the level of the reference signal VREF, each 40 bit of the high-speed data TXN in response to a falling edge of the enable signal ENS. Thus, one time under sampling is performed every 40 bits of the high-speed data TXN in response to the enable signal ENS.

The level of the high-speed data TXN is compared with the level of the reference signal VREF for a high M/2 bit time of the high-speed data TXN and the signal OUTS is stored in the storage circuit 340 for a low M/2 bit time. Accordingly, since M is 40, the level of the high-speed data TXN is compared with the level of the reference signal VREF for high 20 bit time of the high-speed data TXN and the signal OUTS is stored in the storage circuit 20 for low 20 bit time of the high-speed data TXN.

If the high-speed data TXN is low, the levels of the reference signal VREF are higher than the levels of the high-speed data TXN in the other sections, except for a section iv where the level of the reference signal VREF is lower than the level of the high-speed data TXN. Thus, low level signals OUTS are output. Thus, many low level signals OUTS are output in a section i where the high-speed data TXN is low.

If the high-speed data TXN is high, the level of the reference signal VREF is lower than the level of the high-speed data TXN. However, this is not the case in a section v, where the level of the reference signal VREF is higher than the level of the high-speed data TXN. Thus, the signal OUTS becomes high. In other words, many waves of the signal OUTS become high in a section ii where the high-speed data TXN is high.

If rising sections increase, where the levels of the high-speed data TXN are higher than the levels of the reference signal VREF, the number of output high level signals OUTS increases. In contrast, if falling sections increase, where the levels of the high-speed data TXN are lower than the levels of the reference signal VREF, the number of output low level signals OUTS increases.

Therefore, in the low level sections of the high-speed, data TXN, a number of signals OUTS are output as low levels, and a ratio of the low levels to the high levels is regular. However, the number of signals OUTS output as high levels increases in the rising sections of the high-speed data TXN, and the number of signals OUTS output as low levels increases in the falling sections of the high-speed data TXN.

Accordingly, the storage circuit 340 stores signals OUTS output from sections where the number of low or high levels of the signals OUTS gradually increases or decreases. Also, the number of samplings is obtained in the sections for obtaining times of the rising or failing sections of the high-speed data TXN. Since the number of the output signals OUTS is equal to the number of samplings, the times of rising or falling sections of the high-speed data TXN can be obtained using the number of the output signals OUTS. Sections within a range of 20-80% are detected from the obtained times and rising or falling times of the high-speed data TXN are measured from the number of samplings.

As described above, the circuit and method according to the present invention can measure rising or falling time of high-speed data without using an external measuring instrument.

The embodiments of the present invention described and illustrated herein are merely exemplary of the present invention and may be altered by those of ordinary skill in the art without departing spirit and scope of the present invention. For example, although the exemplary embodiment illustrated in FIG. 3 includes specific elements constructive in describing an operational aspect of the present invention, other components and/or elements may also be included as desired without departing from the spirit of the present invention. Furthermore, although FIG. 9 illustrates the DUT board 910 as including the data generator 930 and the comparator 940 in one contiguous unit, it is clear to those of ordinary skill in the art that these elements may be noncontiguous without departing from the spirit of the present invention. Moreover, although the ATE 920 is illustrated as being separate from the DUT board 910, these two elements may be integrated as one unit without departing from the spirit of the present invention. With regard to the ATE 920, as with the DUT board 910, the specific elements thereof may by integral to the ATE 920 or separate therefrom without departing from the scope of the present invention. Other various configurations not illustrated and/or discussed herein are equally embraced by the present invention, as is understood by those of ordinary skill in the art.

Although the invention has been described with reference to the exemplary embodiments shown in the drawings, the drawings are for illustrative purpose only. The scope of the present invention must not be interpreted as being restricted to the embodiments. Therefore, it will be apparent to one of ordinary skill in the art that modifications of the described embodiments may be made without departing from the spirit and scope of the invention.

What is claimed is:

1. A circuit for measuring rising or falling time of data, the circuit comprising:
a comparator for receiving data via a port and a reference signal via another port, the comparator comparing a level of the data with a level of the reference signal in response to an enable signal, and outputting the compared result as a signal; and
a storage circuit for receiving and storing the signal and measuring the rising or falling time of the data.

2. The circuit of claim 1, wherein the reference signal has a stepped waveform and a period of one step thereof is T, and a high level and a low level of the reference signal are distinguished by N steps.

3. The circuit of claim 2, wherein a duration of the period T is greater than an M bit time of the high-speed data, the duration being greater by a time T1.

4. The circuit of claim 3, wherein the comparator compares a level of the data with the level of the reference signal for an upper M/2 bit time of the data in response to the enable signal, and the storage circuit stores the signal for a lower M/2 bit time of the data.

5. The circuit of claim 2, wherein a high level of the reference signal is higher than a high level of the data, and a low level of the reference signal is lower than a low level of the data.

6. The circuit of claim 2, wherein the enable signal has the same period as the period T of one step of the reference signal, and the level of the data is compared with the level of the reference signal in response to a first edge of the enable signal.

7. A system for measuring rising or falling time of data, the system comprising:
a device under test board for receiving data and a reference signal, comparing a level of the data with a level of the reference signal in response to an enable signal, and outputting the compared result as a signal; and
an automatic test equipment for generating the reference signal and the enable signal, receiving the signal, and measuring the rising or falling time of the data.

8. The system of claim 7, wherein the device under test board comprises:
a data generator for generating the data; and
a comparator for receiving the data via a first port and the reference signal via a second port and outputting the signal in response to the enable signal.

9. The system of claim 7, wherein the automatic test equipment comprises:
a reference signal generator for generating the reference signal;
an enable signal generator for generating the enable signal; and
a storage circuit for receiving and storing the signal and measuring the rising or falling time of the data.

10. The system of claim 7, wherein the reference signal has a stepped waveform and a period of one step thereof is T, and a high level and a low level of the reference signal are distinguished by N step(s).

11. The system of claim 10, wherein a duration of the period T is greater than an M bit time of the high-speed data, the duration being greater by a time T1.

12. The system of claim 11, wherein the comparator compares the level of the data with the level of the reference signal for an upper M/2 bit time of the data in response to the enable signal, and the storage circuit stores the signal for a lower M/2 bit time of the data.

13. The system of claim 10, wherein a high level of the reference signal is higher than a high level of the data, and a low level of the reference signal is lower than a low level of the data.

14. The system of claim 10, wherein the enable signal has the same period as the period T of one step of the reference signal, and the level of the data is compared with the level of the reference signal in response to a first edge of the enable signal.

15. A method of measuring rising or falling time of data, the method comprising:
receiving data and a reference signal;
comparing a level of the data with a level of the reference signal in response to an enable signal and outputting the compared result as a signal; and
storing the signal in a memory array and measuring the rising or falling time of the data from the stored signal.

16. The method of claim 15, wherein the reference signal has a stepped waveform and a period of one step thereof is T, and high level and low level of the reference are distinguished by N step(s).

17. The method of claim 16, wherein a duration of the period T is greater than an M bit time of the high-speed data, the duration being greater by a time T1.

18. The method of claim 17, wherein the level of the data is compared with the level of the reference signal for an upper M/2 bit time of the data in response to the enable signal, and the signal is stored in the memory array for a lower M/2 bit time of the high-speed data.

19. The method of claim 16, wherein a high level of the reference signal is higher than a high level of the data, and a low level of the reference signal is lower than a low level of the data.

20. The method of claim 16, wherein the enable signal has the same period as the period T of one step of the reference signal, and the level of the data is compared with the level of the reference signal in response to a first edge of the enable signal.

21. The circuit according to claim 1, wherein the data is high-speed data.

22. The system according to claim 7, wherein the data is high-speed data.

23. The method according to claim 15, wherein the data is high-speed data.
